(19) United States
(12) Patent Application Publication
(10) Pub. No.: US 2016/0034662 A1
(43) Pub. Date: Feb. 4, 2016

(54) SYSTEMS, METHODS, AND APPARATUS FOR IDENTIFYING AND MITIGATING POTENTIAL CHRONIC PAIN IN PATIENTS

(71) Applicant: The Travelers Indemnity Company, Hartford, CT (US)

(72) Inventors: Joanne Moynihan, Avon, CT (US); Linda S. Chambers, Andover, CT (US); Linda F. Jamgochian, Feeding Hills, MA (US); Kathleen M. Kamienski, Marlborough, CT (US); Keefe I. Kirshen, Glastonbury, CT (US); Adam L. Seidner, Old Lyme, CT (US); Glen W. Smyth, Canton, CT (US); Mikesh Shivakoti, Manchester, CT (US)

(21) Appl. No.: 14/450,147

(22) Filed: Aug. 1, 2014

(51) Int. Cl. G06F 19/00

(52) U.S. Cl. CPC G06F 19/3431

(57) ABSTRACT

Systems, apparatus, methods, and articles of manufacture provide for identifying and/or managing patients and/or claims in order to prevent the development of chronic pain conditions.

### BACKGROUND

The treatment and management of patients suffering chronic pain conditions is complex and expensive. Despite the difficulty and high cost of treating chronic pain, and its adverse effect on a patient's quality of life, previous practices have failed to optimize the identification and management of patients who are likely to suffer from chronic pain (e.g., in the future). Previous practices also have failed to optimize the information collected to increase the accuracy, consistency, and reliability of assessing potential and/or contributing causes of chronic pain and selecting a management strategy to mitigate the risk of a chronic pain condition.

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a diagram of a system according to an embodiment of the present invention; FIG. 2 is a diagram of a system according to an embodiment of the present invention; FIG. 3 is a diagram of a system according to an embodiment of the present invention; FIG. 4 is a diagram of a computing device according to an embodiment of the present invention;

FIG. 5 is a flowchart of a method according to an embodiment of the present invention;

FIG. 6 is a flowchart of a method according to an embodiment of the present invention;

FIG. 7 is a flowchart of a method according to an embodiment of the present invention;

FIG. 8 is a flowchart of a method according to an embodiment of the present invention;

FIG. 9 is an example interface according to an embodiment of the present invention;

FIG. 10 is an example interface according to an embodiment of the present invention; and

FIG. 11 is an example interface according to an embodiment of the present invention.

### DETAILED DESCRIPTION

Applicants have recognized that, in accordance with one or more embodiments, some types of insurers, insurance policyholders, claimants, injured persons, patients, third-party service providers, claim professionals, medical professionals, and/or other types of users, may find it advantageous to provide, have access to, and/or utilize functions of a pain management service, system, and/or user interface providing for one or more of the following benefits:

a) identifying and/or managing pain experienced by patients, claimants, and/or other types of persons (e.g., injured persons);

b) identifying persons experiencing pain (e.g., acute pain, chronic pain);

c) preventing acute pain from becoming chronic pain; and/or

d) recommending one or more actions for the management or care of a person experiencing pain, to reduce the likelihood that the person experiences chronic pain in the future.

In accordance with some embodiments of the present invention, one or more systems, apparatus, methods, articles of manufacture, and/or computer readable media (e.g., a non-transitory computer readable memory storing instructions for directing a processor) are described that provide for one or more of the following:

a) determining claim and/or other types of information associated with at least one patient, claimant, injured person, or other type of person;

b) determining whether a person is experiencing pain;

c) determining whether a person is experiencing one or more predetermined types and/or categories of pain (e.g., acute pain, chronic pain);

d) determining a likelihood that a person is experiencing and/or may experience in the future, one or more predetermined types and/or categories of pain;

e) determining a likelihood that a person currently experiencing acute pain will experience chronic pain in the future; and/or

f) providing one or more user interfaces (e.g., a claim management interface, a pain management interface).

In accordance with some embodiments of the present invention, one or more systems, apparatus, articles of manufacture, and/or computer readable media are described that provide for one or more of:

a) determining data associated with a person (e.g., patient information, personal information, employment information, medical information, and/or claim information);

b) determining whether the person is accepted into a pain intervention program;

c) accepting the person into a pain intervention program;

d) receiving or otherwise determining an indication of a prediction or likelihood that the person will develop chronic pain (e.g., within a predetermined period of time);

e) determining (e.g., based on data associated with the person) and/or storing an indication of at least one contributing cause of future chronic pain (e.g., at least one factor or pain driver likely to contribute to future chronic pain);

f) determining, recommending, managing, storing an indication of, and/or facilitating at least one action for preventing and/or for reducing the likelihood of future chronic pain (e.g., based on at least one determined contributing cause or factor); and/or

g) determining whether a pain intervention strategy (e.g., comprising one or more actions for preventing and/or reducing the likelihood of future chronic pain) has been successful.

In accordance with some embodiments of the present invention, one or more systems, apparatus, articles of manufacture, and/or computer readable media are described that provide for one or more of:

a) a pain management system;

b) one or more data storage devices storing information about claim and/or other types of information associated with at least one patient, claimant, injured person, or other type of person;

c) one or more data storage devices storing model information (e.g., information defining parameters and/or computer readable software instructions for executing pain detection models and/or pain prediction models);

d) a pain detection model (e.g. for identifying persons experiencing pain based on information about the person);

e) a potential or future chronic pain prediction model (e.g., for identifying persons who may or may not be experiencing chronic pain currently but are likely to experience chronic pain in the future, such as within a predetermined period of time);

f) a pain intervention system; and/or

g) a pain intervention program application.

In accordance with some embodiments of the present invention, one or more systems, apparatus, methods, articles of manufacture, and/or computer readable media are described that provide for one or more interfaces (e.g., a claim management interface, a pain management interface) that may be useful for:

a) for facilitating evaluation of a person for (and/or acceptance of the person into) a pain intervention program;

b) transmitting and/or receiving an indication of one or more recommended actions for preventing chronic pain; and/or

c) storing information about a pain intervention strategy for a person.

In some embodiments a “dashboard” or other type of user interface may be provided that allows a user to identify, be alerted to, manage, and/or otherwise process insurance claims (e.g., associated with a patient, injured person, insurance policyholder, and/or insurance claimant) and/or manage acceptance into, participation in, and/or management under, a pain intervention program.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting.

As used in this disclosure, the term “patient” may be used to refer to a person who has been injured, is or will be receiving medical care, and/or is a claimant for an insurance claim (e.g., workers compensation policy, personal injury, and/or a medical or health insurance policy) associated with an injury to the person or other need for medical treatment. A patient may be, without limitation, a policyholder, an employee of an insurance customer (e.g., a worker making a claim under an employer's workers compensation insurance policy), and/or any other type of individual requiring and/or seeking medical care.

As used in this disclosure, the term “chronic pain” may be used to refer to one or more of the following:

a) pain that persists for a patient for more than a predetermined period of time (e.g., more than 90 days);

b) pain caused by a malfunction of or damage to the nervous system (e.g., due to an injury or illness); and/or

c) pain associated with particular types of injuries and/or conditions, such as, without limitation:
a. neuropathic pain (e.g., pain resulting from damage to nerves);
b. neuralgias (e.g., postherpetic neuralgia, trigeminal neuralgia),
c. chronic radiculopathy,
d. complex regional pain syndrome (CRPS) Type I and Type II (e.g., reflex sympathetic dystrophy (RSD), causalgia),
e. spinal cord injuries,
f. polyneuropathies (e.g., caused by human immune-deficiency virus (HIV), toxins),
g. painful diabetic peripheral neuropathy,
h. cancer,
i. phantom limb pain, and/or
j. demyelination (e.g., related to multiple sclerosis (MS)). In contrast, as used in this disclosure, the term “acute pain” may be used to refer to pain such as, without limitation: temporary nociceptive pain (e.g., pain caused by the irritation of nerve endings (nociceptors)), pain from burns, musculoskeletal pain (e.g., lower back pain), post-surgical pain, and/or post-stroke pain. In some instances, a patient's pain may be a temporary condition (e.g., temporary, acute pain from a twisted ankle); in other cases, nociceptive pain (e.g., persisting for more than 90 days) and/or neuropathic pain may be a chronic pain condition. Some conditions and/or causes of pain, such as pain caused by fibromyalgia or psychogenic pain, may result in pain that is classified as either acute or chronic (e.g., depending on its persistence and/or severity). Some examples of causes of nerve damage, which may result in acute or chronic pain, include, without limitation: metabolic, ischemic, hereditary, compression, traumatic, toxic, infectious, and/or immune-mediated.

Some embodiments described herein are associated with a “user device”, “patient device”, or a “network device.” As used in this disclosure, a patient device is a subset of a user device, and a user device is a subset of a network device. The network device, for example, may generally refer to any device that can communicate via a network, while the user device may comprise a network device that is owned or operated by or otherwise associated with any type of user (e.g., a claim handler or other type of insurance professional, a medical professional (who may or may not be employed by or acting on behalf of an insurance carrier), a claimant, and/or a patient)), and a patient device may comprise a network or user device that is owned or operated by or otherwise associated with a patient. Examples of user and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, a modem, a video game console, or a wireless or cellular telephone. User, patient, and/or network devices may comprise one or more network components.

As used in this disclosure, the term “network component” may refer to a user device or network device, or a component, piece, portion, or combination of user or network devices. Examples of network components may include a Static Random Access Memory (SRAM) device or module, a network processor, and a network communication path, connection, port, or cable.

As used in this disclosure, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration or type that is or becomes known. Communication networks may include, for example, devices that communicate directly or indirectly, via a wired or wireless medium, such as the Internet, intranet, a Local Area Network (LAN), a Wide Area Network (WAN), a cellular telephone network, a Bluetooth® network, a Near-Field Communication (NFC) network, a Radio Frequency (RF) network, a Virtual Private Network (VPN), Ethernet (or IEEE 802.3), Token Ring, or via any appropriate communications means or combination of communications means. Exemplary protocols include but are not limited to: Bluetooth ^{TM}, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), and/or system to system (S2S).

In cases where video signals or large files are being sent over the network, a broadband network may be used to alleviate delays associated with the transfer of such large files, however, such an arrangement is not required.

Each of the devices may be adapted to communicate on such a communication means. Any number and type of machines may be in communication via the network. Where the network is the Internet, communications over the Internet may be through a website maintained by a computer on a remote server or over an online data network, including commercial online service providers, and/or bulletin board systems. In yet other embodiments, the devices may communicate with one another over RF, cable TV, and/or satellite links. Where appropriate, encryption or other security measures, such as logins and passwords, may be provided to protect proprietary or confidential information.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard. Information may, according to some embodiments, be compressed, encoded, encrypted, and/or otherwise packaged or manipulated in accordance with any method that is or becomes known or practicable.

As used in this disclosure, “determining” includes calculating, computing, deriving, looking up (e.g., in a table, database, or data structure), ascertaining, and/or recognizing.

As used in this disclosure, “processor” means any one or more microprocessors, Central Processing Unit (CPU) devices, computing devices, microcontrollers, and/or digital signal processors. As used in this disclosure, the term “computerized processor” generally refers to any type or configuration of primarily non-organic processing device that is or becomes known. Such devices may include, but are not limited to, computers, Integrated Circuit (IC) devices, CPU devices, logic boards and/or chips, Printed Circuit Board (PCB) devices, electrical or optical circuits, switches, electronics, optics and/or electrical traces. As used in this disclosure, “mechanical processors” means a sub-class of computerized processors, which may generally include, but are not limited to, mechanical gates, mechanical switches, cogs, wheels, gears, flywheels, cams, mechanical timing devices, etc.

As used in this disclosure, the terms “computer-readable medium” and “computer-readable memory” refer to any medium that participates in providing data (e.g., instructions) that may be read by a computer and/or a processor. Such a medium may take many forms, including but not limited to non-volatile media, volatile media, and other specific types of transmission media. Non-volatile media include, for example, optical or magnetic disks and other persistent memory. Volatile media include DRAM, which typically constitutes the main memory. Other types of transmission media include coaxial cables, copper wire, and fiber optics, including the wires that comprise a system bus coupled to the processor.

Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “non-transitory” and/or “tangible,” when used in reference to computer-readable media or memories, specifically exclude signals, waves, and wave forms or other intangible or transitory media that may nevertheless be readable by a computer.

Various forms of computer-readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards, or protocols. For a more exhaustive list of protocols, the term “network” is defined above and includes many exemplary protocols that are also applicable here.

In some embodiments, one or more specialized machines, such as a computerized processing device, a server, a remote terminal, and/or a patient device, may implement one or more of the various practices described in this disclosure.

One or more embodiments described in this disclosure may be used for health insurance and/or property/casualty insurance, including, for example, workers compensation insurance, first party medical insurance (e.g., auto, property, general liability), and/or third party medical (e.g., auto, property, general liability), but may also apply to any other areas of insurance or other industries or contexts where a company and/or individual has an interest in predicting, detecting, managing, and/or preventing chronic pain conditions in patients.

A computer system of an insurance company may, for example, comprise various specialized computers that interact to generate, manage, and present information associated with patients and/or claims to one or more types of users (e.g., for the purpose of identifying and/or managing pain), as described in this disclosure.

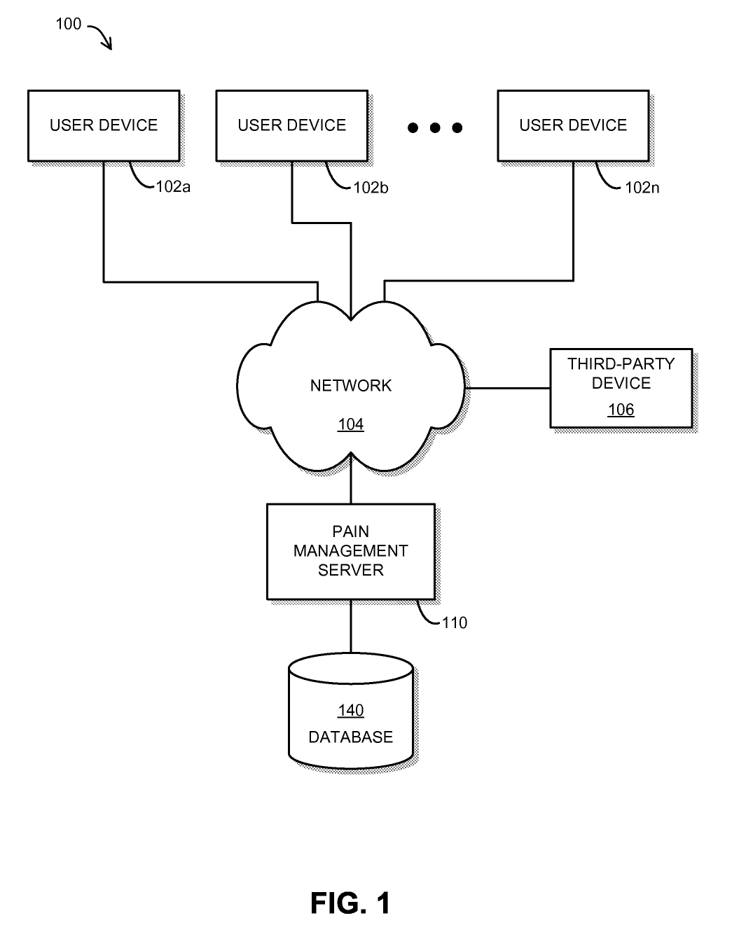

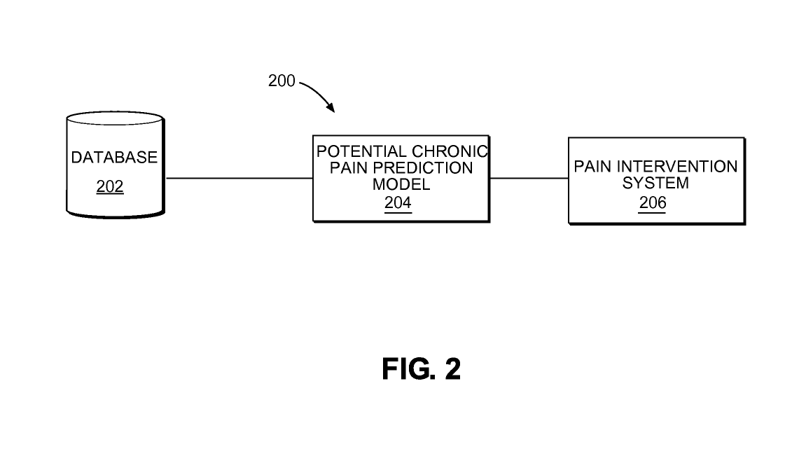

Turning first to FIG. 1, a block diagram of a system 100 according to some embodiments is shown. In some embodiments, the system 100 may comprise a plurality of user devices 102a-n (e.g., owned and/or operated by or on behalf of one or more insurance professionals, medical professionals, claimants, insurance customers, patients, and/or injured persons) in communication with and/or in communication via a network 104. In some embodiments, a pain management server 110 may be in communication with the network 104, one or more of the user devices 102a-n, and/or a third-party device 106 (e.g., owned and/or operated by or on behalf of a third party other than an insurance carrier or patient).

In some embodiments, the pain management server 110, the third-party device 106, and/or the user devices 102a-n may be in communication with a database 140. The database 140 may store, for example, data associated with patients, data associated with one or more claims (e.g., related to patients), and/or instructions that cause one or more various devices (e.g., the pain management server 110 and/or the user devices 102a-n) to operate in accordance with embodiments described in this disclosure.

The user devices 102a-n, in some embodiments, may comprise any type or configuration of electronic, mobile electronic, and or other network and/or communication devices (or combinations thereof) that are or become known or practicable. The first user device 102a may, for example, comprise one or more PC devices, computer workstations (e.g., underwriter workstations), tablet computers, such as an iPad® manufactured by Apple®, Inc. of Cupertino, Calif., and/or cellular and/or wireless telephones, such as an iPhone® (also manufactured by Apple®, Inc.) or an HTC One (M8)™ smartphone manufactured by HTC Corporation, Inc. of Taoyuan, Taiwan, and running the Android® operating system from Google®, Inc. of Mountain View, Calif. In some embodiments, one or more of the user devices 102a-n may be specifically utilized and/or configured (e.g., via specially-programmed and/or stored instructions, such as may define or comprise a software application) to communicate with the pain management server 110 (e.g., via the network 104).

The network 104 may, according to some embodiments, comprise LAN, WAN, cellular telephone network, Bluetooth® network, NFC network, and/or RF network with communication links between the user devices 102a-n, the third-party device 106, the pain management server 110, and/or the database 140. In some embodiments, the network 104 may comprise direct communications links between any or all of the components 102a-n, 106, 110, 140 of the system 100. The pain management server 110 may, for example, be directly interfaced or connected to the database 140 via one or more wires, cables, wireless links, and/or other network components, such network components (e.g., communication links) comprising portions of the network 104. In some embodiments, the network 104 may comprise one or many other links or network components other than those depicted in FIG. 1. The second user device 102b may, for example, be connected to the pain management server 110 via various cell towers, routers, repeaters, ports, switches, and/or other network components that comprise the Internet and/or a cellular telephone (and/or Public Switched Telephone Network (PSTN)) network, and which comprise portions of the network 104.

While the network 104 is depicted in FIG. 1 as a single object, the network 104 may comprise any number, type, and/or configuration of networks that is or becomes known or practicable. According to some embodiments, the network 104 may comprise a conglomeration of different sub-networks and/or network components interconnected, directly or indirectly, by the components 102a-n, 106, 110, 140 of the system 100. The network 104 may comprise one or more cellular telephone networks with communication links between the user devices 102a-n, the third-party device 106, and the pain management server 110, for example, and/or may comprise the Internet, with communication links between the user devices 102a-n and the database 140, for example.

According to some embodiments, the pain management server 110 may comprise a device (and/or system) owned and/or operated by or on behalf of or for the benefit of an insurance company. The insurance company may, for example, utilize patient information, claim information, and/or pain management information (e.g., pain intervention strategies and/or recommended actions for preventing chronic pain) in some embodiments, to manage, generate, analyze, select, and/or otherwise determine information for use in providing customized pain management for patients.

In some embodiments, the insurance company (and/or a third-party) may provide an interface (not shown in FIG. 1) to and/or via one or more of the user devices 102a-n. The interface may be configured, according to some embodiments, to allow and/or facilitate access to services, programs, protocols, modules, information and/or software applications (e.g., web-based applications) for pain management and/or pain intervention, for one or more insurance professionals, medical professionals, patients, and/or other types of users. In some embodiments, the system 100 (and/or the pain management server 110) may present alerts (e.g., of patients eligible for a pain intervention program) and/or recommendations (e.g., of one or more preventative actions to reduce a risk of chronic pain) to one or more types of users based on stored patient information, claim information, predictive model information, and/or pain intervention program information (e.g., from the database 140).

In some embodiments, the database 140 may comprise any type, configuration, and/or quantity of data storage devices that are or become known or practicable. The database 140 may, for example, comprise an array of optical and/or solid-state hard drives configured to store data and/or various operating instructions, drivers, etc. While the database 140 is depicted as a stand-alone component of the system 100 in FIG. 1, the database 140 may comprise multiple components. In some embodiments, a multi-component database 140 may be distributed across various devices and/or may comprise remotely dispersed components. Any or all of the user devices 102a-n, the pain management server 110, and/or the third-party device 106 may comprise the database 140 or a portion thereof.

Referring now to FIG. 2, a block diagram of a system 200 according to some embodiments is shown. In some embodiments, the system 200 may comprise a potential chronic pain prediction model 204 in communication with a pain intervention system 206. One or more of the potential chronic pain prediction model 204 and/or the pain intervention system 206 may be in communication with a database 202 and/or with one or more third-party devices or systems (not shown) operated, for example, by or on behalf third parties supplying data and/or medical services to users of a pain management system.

According to some embodiments, the database 202 may store, for example: data associated with patients; data associated with one or more claims (e.g., related to patients); parameters, values, algorithms, equations, and/or other types of information that may be utilized by the potential chronic pain prediction model 204; and/or instructions that cause one or more of the model 204 and/or the pain intervention system 206 to operate in accordance with embodiments described in this disclosure.

According to one or more embodiments, the potential chronic pain prediction model 204 may comprise one or more algorithms and/or computer-readable instructions configured to identify patients (e.g., injured workers) who may experience chronic pain in the future or may develop a chronic pain condition. In some embodiments, the potential chronic pain prediction model 204 may comprise one or more algorithms for identifying claims (e.g., workers compensation claims) that may develop into a chronic pain claim. Once patients and/or claims are identified, for example, the pain intervention system 206 may alert a user (not shown) of the system and/or the system may be used to develop a strategy to manage the identified patients and/or claims effectively. The potential chronic pain prediction model 204 may, for example, provide the ability to identify (e.g., based on specific claim characteristics associated with a person) when a claim and/or person is beginning to exhibit characteristics indicating that the person's condition may deviate from the expected or desired course. For instance, the prediction model, based on a patient's medical information, claim information, and/or other information, may indicate that an acute pain condition may not be temporary and/or may have a cause that could (potentially) lead to a chronic pain condition.

In some embodiments, one or more of the database 202, potential chronic pain prediction model 204, and/or pain intervention system 206 may be and/or may comprise components of a pain management system. In some embodiments, the system 200 defines a pain management system for facilitating the identification and/or management of patients in order to prevent and/or reduce the likelihood that patients experience future chronic pain. In some embodiments, a pain management system comprises potential chronic pain prediction model 204 (e.g., for identifying potential chronic pain sufferers) and pain intervention system 206 (e.g., for determining actions to prevent chronic pain in patients identified by the potential chronic pain prediction model). In one example, the potential chronic pain prediction model is configured to identify patients not experiencing pain and/or experiencing acute pain, but not experiencing chronic pain.

In some embodiments, an indication of any claim and/or person identified or flagged by the potential chronic pain prediction model 204 may be transmitted to the pain intervention system 206 (e.g., for displaying or otherwise providing to a claim professional or other type of user). In one or more embodiments, the pain intervention system 206 may comprise a pain program intake tool (e.g., embodied as a web-based user interface) for use by an insurance professional (e.g., a claim professional, a nurse) to elicit, receive, and/or enter information about an injured person. In one embodiment, the information about the injured person may be acquired from the person by an insurance professional (e.g., via a telephonic or other type of communication) and/or may be received from the person (e.g., by the person transmitting the information to a web server of the pain intervention system 206 via a webpage form). In accordance with one or more embodiments described in this disclosure, the pain intervention system 206 may determine one or more root causes or “drivers” of an underlying problem based on information about a patient (e.g., based on information stored in database 202 and/or based on information provided by the patient in a pain program intake process). Based on the determined contributing causes of future chronic pain (also referred to in this disclosure as “pain drivers”), the pain intervention system 206 may identify and provide indications of one or more recommended actions (e.g., pain intervention program resources, medical assessments, and/or investigative or diagnostic services) directed to preventing, reducing the severity of, and/or reversing a chronic pain condition.

Referring now to FIG. 3, a block diagram of a system 300 according to some embodiments is shown. In some embodiments, the system 300 may be similar in configuration and/or functionality to the pain management server 110, and/or may comprise one or more portions of the system 200. The system 300 may, for example, execute, process, facilitate, and/or otherwise be associated with methods described in this disclosure. Fewer or more of the depicted components of system 300 (and/or portions thereof) and/or various configurations of the depicted components may be included in the system 300 without deviating from the scope of embodiments described in this disclosure. Any device depicted in the system 300 may comprise a single device, a combination of devices and/or components, and/or a plurality of devices, as is or becomes desirable and/or practicable. Similarly, in some embodiments, one or more of the various components may not be needed and/or desired in the system 300.

In some embodiments, the system 300 may comprise claim data 302a, medical data 302b, third-party data 302c, a chronic pain prediction server 304, a pain intervention server 314, a service provider device 332, and/or a patient device 334.

In some embodiments, the chronic pain prediction server 304 may comprise a controller 306 (e.g., a computer or other type of computing device, such as processing device 432 of FIG. 4) and/or a memory device 308, and may be similar in configuration and/or functionality to the potential chronic pain prediction model 204. The memory device 308 may, according to some embodiments, store one or more of: potential chronic pain prediction module 310 and/or model data 312. In some embodiments, the potential chronic pain prediction module 310 may comprise instructions for directing the controller 306 to identify one or more patients who may develop a chronic claim condition (e.g., based on claim data 302a, medical data 302b, and/or third-party data 302c). In one embodiment, the potential chronic pain prediction module 310 may be executed by the controller 306 in accordance with the model data 312, which may include one or more parameters for use in identifying claims and/or patients having particular characteristics indicative of a potential or future chronic pain condition. In some embodiments, the controller 306 may transmit an alert or other type of signal to the pain intervention server 314, service provider device 332, and/or patient device 334, indicating one or more patients and/or claims for which chronic pain condition is predicted and/or for which consideration for, eligibility for, or acceptance into a pain intervention program is recommended and/or determined.

In some embodiments, the pain intervention server 314 may comprise a controller 316 (e.g., a processing device) and/or a memory device 318, and may be similar in configuration and/or functionality to the pain intervention system 206. The memory device 318 may, according to some embodiments, store one or more of: alert module 320, program intake module 322, pain driver analysis module 324, pain strategy outcome module 326, program data 328, and/or resource data 330.

In some embodiments, the modules 320, 322, 324, and/or 326 may comprise instructions (e.g., computer-readable software instructions or computer programs) for directing the controller 306 to perform one or more of various processes and/or functions described in this disclosure. Alert module 320 may comprise instructions for directing the controller 316 (e.g., in response to information or alerts received from chronic pain prediction server 310) to generate one or more alerts, signals, messages, displays, and/or other types of communications to inform one or more systems and/or users (e.g., via a claim management interface) that one or more patients and/or claims have been flagged, referred to, and/or should be considered for participation in, a pain intervention program. In some embodiments, if a possible referral to a pain intervention program (e.g., for a person whose claim characteristics suggest a chronic pain condition may be likely) is detected (e.g., by and/or in response to a signal from the potential chronic pain prediction module 310), an alert may be generated and delivered, for example, via electronic mail, short message service (SMS) text message, multimedia message service (MMS) text message, display device, or any other form of electronic or optical communication. For example, a claim handler or other insurance professional may review a claim flagged in a claim management interface to determine or confirm the circumstances or reasons the claim was flagged, and/or to accept or reject a patient for a pain intervention program. In some embodiments, the alert module 320 may be stored by and/or executed by the chronic pain prediction server 304, and/or the potential chronic pain prediction module 310 may include instructions for transmitting alerts to one or more other systems and/or users.

Program intake module 322 may comprise instructions for directing the controller 316 to provide one or more interfaces for receiving information about a patient (e.g., for whom future chronic pain has been predicted) qualifying for and/or recommended for a pain intervention program. In some embodiments, program intake module 322 may include instructions for directing the processor 316 to display or otherwise transmit to a user (e.g., a patient, a claim professional) one or more questions (e.g., a questionnaire, a survey) to which a patient may provide responses. For example, a claim professional may be prompted by a user interface to ask a patient one or more questions via telephone and/or via an instant messaging or chat function of a webpage. In another example, a patient may provide information in an intake process via a browser application running on patient device 334. Some examples of the types of information that may be requested from and/or provided by a patient are discussed in this disclosure with respect to some example interfaces.

Pain driver analysis module 324 may comprise instructions for directing the controller 316 to determine (e.g., based on information about a patient determined by the program intake module 322) one or more pain drivers that may contribute to the patient experiencing and/or reporting chronic pain (currently and/or in the future) and/or may contribute to an associated claim being characterized (e.g., by an insurance company) as a chronic pain claim. In some embodiments, information acquired from a patient (e.g., about his or her current quality of life, perceived level of pain, etc.) may be analyzed, scored, ranked, and/or otherwise processed to determine whether the patient may be associated with any one or more a predetermined set of potential pain drivers. In one embodiment, information about potential pain drivers, such as, without limitation, descriptions of pain drivers, any associated minimum threshold scores or other values for use in identifying potential pain drivers, and/or patient scores or other indicia with respect to one or more pain drivers (e.g., a patient score for a particular pain driver) may be stored in and/or accessed from program data 328. Pain driver analysis module 324 may further comprise instructions for directing the controller 316 to output (e.g., via a user interface) an indication of one or more potential pain drivers associated with a patient and/or with a claim. In accordance with one or more embodiments, potential pain drivers considered by the pain driver analysis module 324 may include, without limitation, one or more of the following:

a) Ineffective treatment (e.g., the patient may not be receiving effective treatment for current pain, treatment may not be consistent with medical treatment guidelines, patient may not be improving, etc.);

b) Functional ability (e.g., the patient's ability to return to work);

c) Pain intensity (e.g., the patient may experiencing an increase in perceived pain);

d) Psychiatric issues; and/or

e) Substance abuse/addiction (e.g., does the patient's pharmacy history indicate a substance problem?).

Pain strategy outcome module 326 may comprise instructions for directing the controller 316 to determine and/or document one or more actions (e.g., preventative actions) for mitigating the risk that a patient will remain or become a chronic pain sufferer. In one embodiment, one or more preventative actions (e.g., engaging a particular service, requesting an investigative or diagnostic procedure) may be identified based on a potential pain driver identified by pain driver analysis module 324. In one embodiment, each respective pain driver may be associated (e.g., in resource data 330) with one or more corresponding resources and/or tools that may be helpful in addressing and/or mitigating the impact of that pain driver on the patient and/or the claim. Some examples of preventative actions include, without limitation, one or more of:

a) a consultation (e.g., by an insurance professional) with a medical professional (e.g., a patient's primary physician),

b) conducting a treatment effectiveness review,

c) a consultation between two medical professionals,

d) a peer review of a physician,

e) a review of medical records,

f) replacement of a first treating physician with a second treating physician,

g) a diagnostics assessment,

h) a nerve conduction quality assessment,

i) a radiological quality assessment,

j) a medical fraud review,

k) a pain management consultation,

l) identifying available light duty jobs,

m) ergonomic review,

n) surveillance of the person,

o) vocational rehabilitation for the person,

p) review of pharmacy guidelines (e.g., state pharmacy protocols), and/or

q) consultation with a pharmacist.

In some embodiments, the pain strategy outcome module 326 may comprise instructions for directing the controller to prompt for, receive, transmit, and/or store (e.g., in program data 328) an indication of a pain intervention strategy identifying one or more actions to take with respect to a patient and/or claim. In one embodiment, the pain strategy outcome module 326 may facilitate the updating by a user (e.g., a claim professional) of claim file notes with information about a pain intervention strategy (e.g., information identifying any vendor or service provider to be utilized).

In some embodiments, the pain intervention server 314 (e.g., in accordance with the pain strategy outcome module 326 and/or pain driver analysis module 324) may transmit a request or other type of signal to a service provider device 332 that is operated by or on behalf of a vendor or other type of service provider. In one example, if a particular resource is to be engaged as part of a pain intervention strategy (e.g., a peer review of a patient's medical history is desired), the pain intervention server 314 may transmit a request to the service provider device 332 corresponding to the service provider providing that resource. Although only one service provider device 332 is depicted in the system 300, it will be readily understood that any number of service provider devices may be in communication with one or more components of the system 300.

Turning to FIG. 4, a block diagram of an apparatus 430 according to some embodiments is shown. In some embodiments, the apparatus 430 may be similar in configuration and/or functionality to any of the user devices 102a-n and/or the pain management server 110 of FIG. 1 and/or may comprise one or more portions of the systems 200 (FIG. 2) or 300 (FIG. 3). The apparatus 430 may, for example, execute, process, facilitate, and/or otherwise be associated with methods described in this disclosure.

In some embodiments, the apparatus 430 may comprise a processing device 432, an input device 434, an output device 436, a communication device 438, and/or a memory device 440. According to some embodiments, any or all of the components 432, 434, 436, 438, 440 of the apparatus 430 may be similar in configuration and/or functionality to any similarly named and/or numbered components described herein. Fewer or more components 432, 434, 436, 438, 440 and/or various configurations of the components 432, 434, 436, 438, 440 may be included in the apparatus 430 without deviating from the scope of embodiments described herein.

According to some embodiments, the processing device 432 may be or include any type, quantity, and/or configuration of electronic and/or computerized processor that is or becomes known. The processing device 432 may comprise, for example, an Intel® IXP 2800 network processor or an Intel® XEON™ Processor coupled with an Intel® E7501 chipset. In some embodiments, the processing device 432 may comprise multiple inter-connected processors, microprocessors, and/or micro-engines. According to some embodiments, the processing device 432 (and/or the apparatus 430 and/or portions thereof) may be supplied power via a power supply (not shown), such as a battery, an alternating current (AC) source, a direct current (DC) source, an AC/DC adapter, solar cells, and/or an inertial generator. In the case that the apparatus 430 comprises a server, such as a blade server, necessary power may be supplied via a standard AC outlet, power strip, surge protector, and/or uninterruptible power supply (UPS) device.

In some embodiments, the input device 434 and/or the output device 436 are communicatively coupled to the processing device 432 (e.g., via wired and/or wireless connections and/or pathways) and they may generally comprise any types or configurations of input and output components and/or devices that are or become known, respectively. The input device 434 may comprise, for example, a keyboard that allows an operator of the apparatus 430 to interface with the apparatus 430. In some embodiments, the input device 434 may comprise a sensor configured to provide information to the apparatus 430 and/or the processing device 432. The output device 436 may, according to some embodiments, comprise a display screen and/or other practicable output component and/or device. The output device 436 may, for example, provide a pain program intake module to a user (e.g., via a website accessible using a user device). According to some embodiments, the input device 434 and/or the output device 436 may comprise and/or be embodied in a single device, such as a touch-screen monitor.

In some embodiments, the communication device 438 may comprise any type or configuration of communication device that is or becomes known or practicable. The communication device 438 may, for example, comprise a network interface card (NIC), a telephonic device, a cellular network device, a router, a hub, a modem, and/or a communications port or cable. In some embodiments, the communication device 438 may be coupled to provide data to a user device (not shown in FIG. 4), such as in the case that the apparatus 430 is utilized to serve a pain intervention application to one or more users as described in this disclosure. The communication device 438 may, for example, comprise a cellular telephone network transmission device that sends signals to a user device. According to some embodiments, the communication device 438 may also or alternatively be coupled to the processing device 432. In some embodiments, the communication device 438 may comprise an IR, RF, Bluetooth™, and/or Wi-Fi® network device coupled to facilitate communications between the processing device 432 and another device (such as a user device and/or a third-party device).

The memory device 440 may comprise any appropriate information storage device that is or becomes known or available, including, but not limited to, units and/or combinations of magnetic storage devices (e.g., a hard disk drive), optical storage devices, and/or semiconductor memory devices, such as RAM devices, read only memory (ROM) devices, single data rate random access memory (SDR-RAM), double data rate random access memory (DDR-RAM), and/or programmable read only memory (PROM).

The memory device 440 may, according to some embodiments, store one or more of: chronic pain prediction model instructions 442-1, pain management interface instructions 442-2, claim data 444-1, patient data 444-2, medical data 444-3, pain program data 444-4, and/or model data 444-5.

In some embodiments, the chronic pain prediction model instructions 442-1 may be utilized by the processing device 432 to identify one or more patients and/or claims that are or may become associated with chronic pain and/or to output an indication of such patients and/or claims (e.g., by providing alerts to users via the output device 436 and/or the communication device 438). According to some embodiments, the chronic pain prediction model instructions 442-1 may be operable to cause the processing device 432 to process claim data 444-1, patient data 444-2, medical data 444-3, and/or model data 444-5, in order to determine whether certain information associated with a patient or claim meets one or more criteria (e.g., stored in model data 444-5) for referring to or flagging for a pain intervention program. Claim data 444-1, patient data 444-2, and/or medical data 444-3 received via the input device 434 and/or the communication device 438 may, for example, be analyzed, sorted, filtered, and/or otherwise processed by the processing device 432 in accordance with the chronic pain prediction model instructions 442-1 and model data 444-5.

In some embodiments, the pain management interface instructions 442-2 may be utilized by the processing device 432 to output an indication of patients and/or claims flagged by the chronic pain prediction model instructions 442-1 (e.g., via the output device 436 and/or the communication device 438), to facilitate the acceptance of a patient into a pain intervention program, to receive information about a patient (e.g., during a pain intervention program intake procedure), to facilitate the documentation of a pain intervention strategy, and/or to output an indication of one or more pain drivers and/or associated preventative actions or resources (e.g., stored in pain program data 444-4).

Any or all of the exemplary instructions and data types described herein and other practicable types of data may be stored in any number, type, and/or configuration of memory devices that is or becomes known. The memory device 440 may, for example, comprise one or more data tables or files, databases, table spaces, registers, and/or other storage structures. In some embodiments, multiple databases and/or storage structures (and/or multiple memory devices 440) may be utilized to store information associated with the apparatus 430. According to some embodiments, the memory device 440 may be incorporated into and/or otherwise coupled to the apparatus 430 (e.g., as shown) or may simply be accessible to the apparatus 430 (e.g., externally located and/or situated).

In some embodiments, the apparatus 430 may comprise a cooling device 450. According to some embodiments, the cooling device 450 may be coupled (physically, thermally, and/or electrically) to the processing device 432 and/or to the memory device 440. The cooling device 450 may, for example, comprise a fan, heat sink, heat pipe, radiator, cold plate, and/or other cooling component or device or combinations thereof, configured to remove heat from portions or components of the apparatus 430.

According to some embodiments, processes described in this disclosure may be performed and/or implemented by and/or otherwise associated with one or more specialized and/or computerized processing devices, specialized computers, computer terminals, computer servers, computer systems and/or networks, and/or any combinations thereof. In some embodiments, methods may be embodied in, facilitated by, and/or otherwise associated with various input mechanisms and/or interfaces.

Any processes described in this disclosure do not necessarily imply a fixed order to any depicted actions, steps, and/or procedures, and embodiments may generally be performed in any order that is practicable unless otherwise and specifically noted. Any of the processes and/or methods described in this disclosure may be performed and/or facilitated by hardware, software (including microcode), firmware, or any combination thereof. For example, a storage medium (e.g., a hard disk, universal serial bus (USB) mass storage device, and/or digital video disk (DVD)) may store thereon instructions that when executed by a machine (such as a computerized processing device) result in performance according to any one or more of the embodiments described in this disclosure.

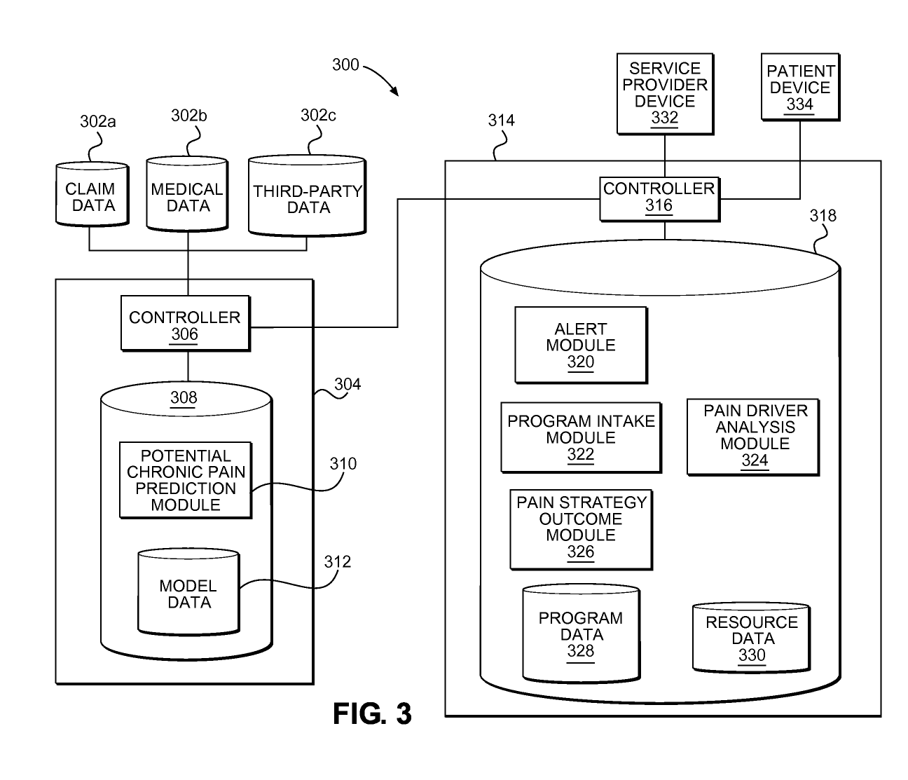

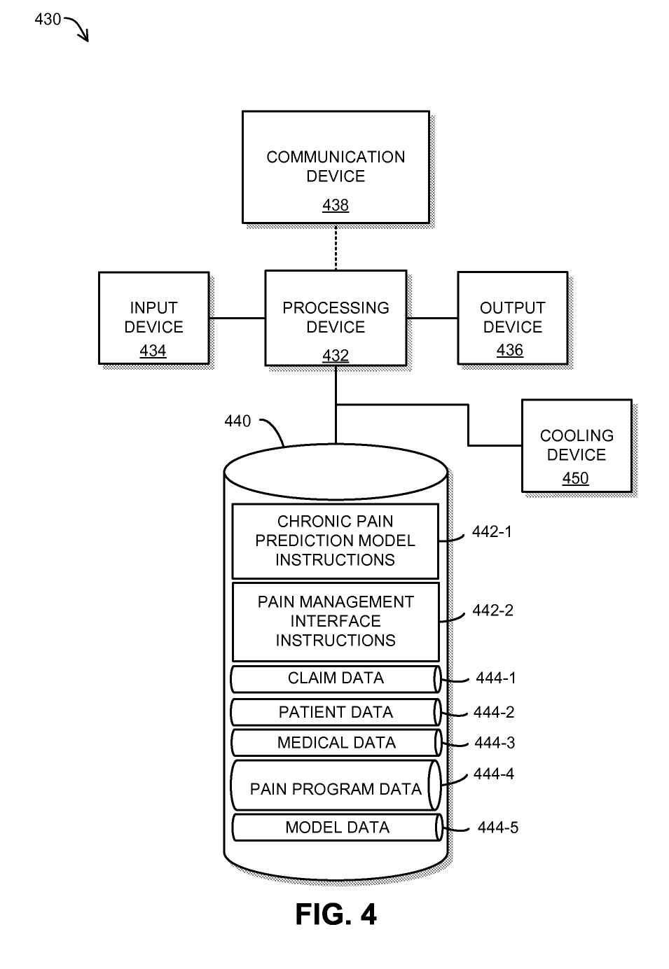

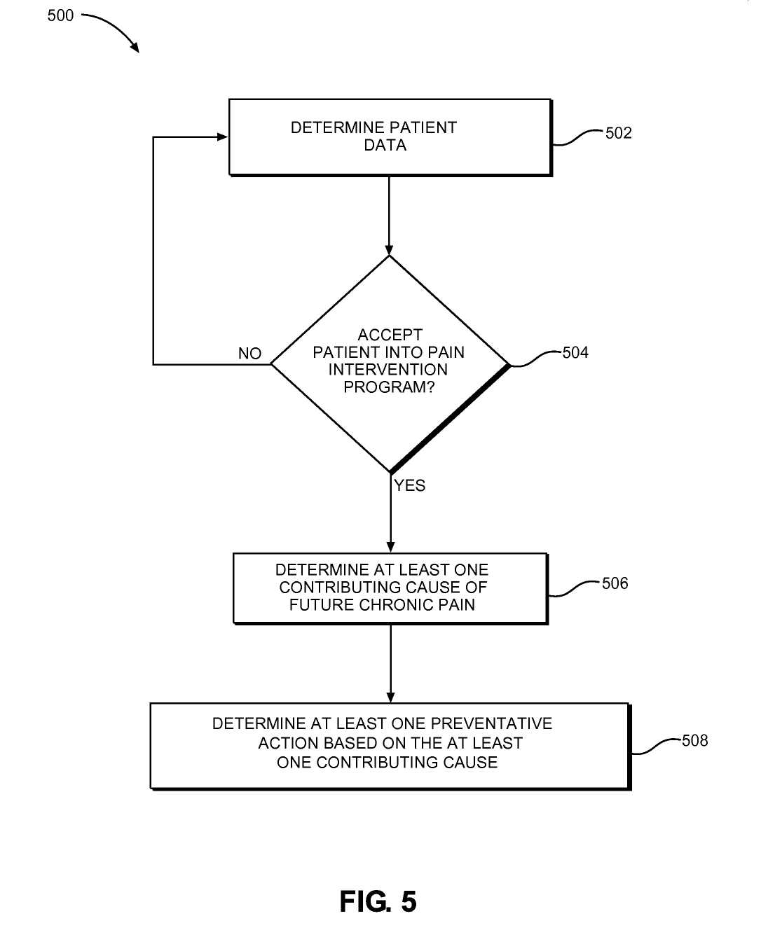

Referring now to FIG. 5, a flow diagram of a method 500 according to some embodiments is shown. The method 500 may be performed, for example, by a server computer (e.g., executing a chronic pain prediction model) or one or more other types of computing devices. It should be noted that although some of the steps of method 500 may be described as being performed by a server computer (e.g., a pain management server), while other steps are described as being performed by another computing device, any and all of the steps may be performed by a single computing device which may be a mobile device, desktop computer, or another computing device. Further, any steps described herein as being performed by a particular computing device may, in some embodiments, be performed by a human or another computing device as appropriate.

According to some embodiments, the method 500 may comprise determining patient data, at 502. In some embodiments, patient data may comprise one or more of: a person's medical history, claim information about an insurance claim associated with the person, other personal information (e.g., age, residence, marital status), and/or information about the person's employment (e.g., physical demands of the job, length of employment, compensation or salary information). Determining the patient data may comprise, in accordance with some embodiments, one or more of: reviewing the person's medical history, accessing stored electronic data; receiving the information via a user interface (e.g., from a claim professional or other user) or input device; and/or receiving a signal including an indication of the information from a user computer, web server, server computer, claim management system, and/or third-party data device.

According to some embodiments, the method 500 may further comprise determining whether a patient is accepted into a pain intervention program, at 504. Determining whether a patient is accepted may comprise one or more of: determining that a patient is likely to develop a chronic pain condition; determining that a claim associated with the patient is likely to develop into a chronic pain claim; receiving an indication that a patient is accepted; and/or determining, based on patient data, that the patient is accepted. In some embodiments, a patient may be accepted automatically into a pain intervention program (e.g., in response to a determination by a potential chronic pain prediction module based on patient data that the patient is likely to experience chronic pain). In one embodiment, a user (e.g., a claim professional) may indicate (e.g., via a pain management interface) that a patient is accepted into a pain intervention program. In some embodiments, a patient may be flagged for or referred to a pain intervention program (e.g., by a potential chronic pain prediction module), but a user (e.g., in response to an alert via an interface that the patient has been flagged) must review the patient data and make a decision as to whether the patient should be accepted into the program or not.

If the patient is not accepted, the method 500 may determine patient data again (e.g., for the same patient or one or more different patients) at 502. If the patient is accepted, the method 500 may further comprise determining at least one contributing cause of future chronic pain, at 506. As discussed in this disclosure, one or more contributing causes or pain drivers may be determined based on information associated with a patient, such as claim data and/or information provided by a patient during a pain intervention program intake. In some embodiments, determining at least one contributing cause of future chronic pain may comprise scoring a patient's responses to one or more queries (e.g., by a claim professional) and identifying one or more pain drivers based on whether a predetermined minimum score for a particular pain driver is met by the patient's response(s).

According to some embodiments, the method 500 may further comprise determining at least one preventative action based on the at least one contributing cause, at 508. As discussed in this disclosure, various types of embodiments may provide for determining, identifying, and/or selecting one or more actions for addressing and/or mitigating the impact of potential pain drivers. In one embodiment, determining a preventative action may comprise accessing indications of services, tools, or other types of resources associated with a particular pain driver, and/or selecting one or more of such resources as part of a pain intervention strategy for a patient. In some embodiments, one or more preventative actions may be determined automatically by a computing device in accordance with one or more modules or predetermined rules. In some embodiments, one or more preventative actions may be selected by one or more users (e.g., based on a review of patient data and/or intake procedure information).

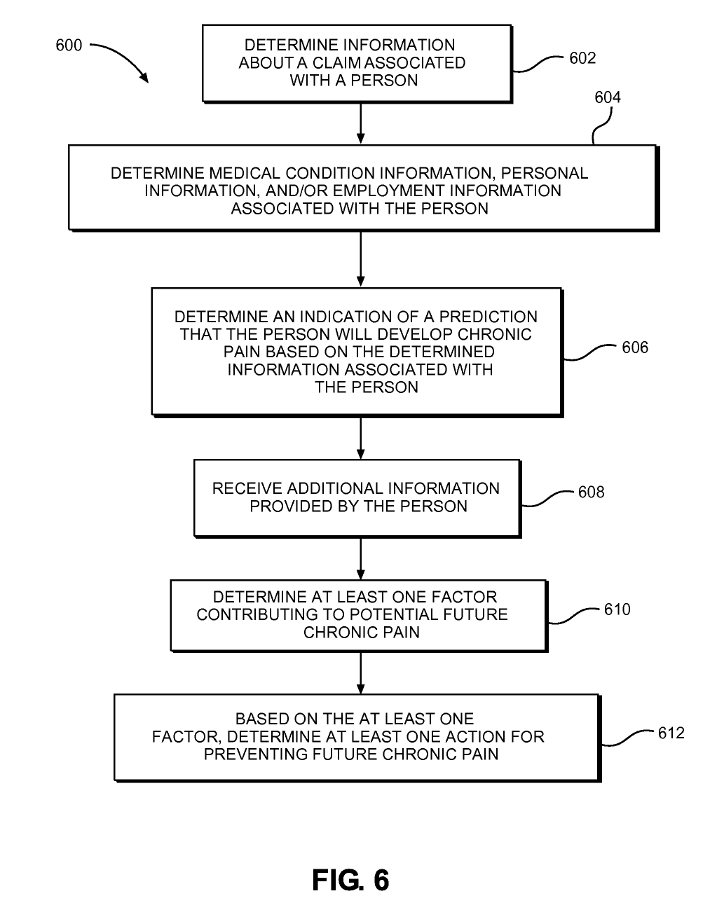

Referring now to FIG. 6, a flow diagram of a method 600 according to some embodiments is shown. The method 600 may be performed, for example, by a server computer. It should be noted that although some of the steps of method 600 may be described as being performed by a server computer (e.g., a pain management server), while other steps are described as being performed by another computing device, any and all of the steps may be performed by a single computing device which may be a mobile device, desktop computer, or another computing device. Further, any steps described herein as being performed by a particular computing device may, in some embodiments, be performed by a human or another computing device as appropriate.

According to some embodiments, the method 600 may comprise determining information about a claim associated with a person, at 602. Information about a claim associated with a person may comprise, without limitation, one or more of: a date of an accident involving the person, a geographical jurisdiction associated with a claim, an indication of whether there was a witness to an injury, a date of attorney representation, a current full duty release target date, an industry (e.g., SIC) code, a full duty return to work date, an indication of whether there was an actual modified duty return to work, an indication of whether modified duty is available, and/or an indication of whether the person is expected to return to work if modified duty is available. Determining the claim information may comprise one or more of: reviewing claim information associated with a person, accessing stored electronic data including claim information; receiving an indication of claim information via a user interface (e.g., from a claim professional or other user) or input device; and/or receiving a signal including an indication of claim information from a client computer, and/or third-party data device. In one example of determining claim information, a potential chronic pain prediction server sends a request to and/or receives claim information from a server computer (e.g., storing claim data).

According to some embodiments, the method 600 may comprise determining one or more of: medical condition information (e.g., information about a medical condition of a person), personal information, and/or employment information associated with the person, at 604. Medical information may include, without limitation, at least one of: an injury type, an indication of an initial treatment of a medical condition, at least one comorbidity, an indication of a diagnosis and/or diagnosis code (e.g., International Classification of Disease (ICD) codes), an indication of a treatment and/or procedural code (e.g., National Counsel of Compensation Insurance (NCCI) codes, Current Procedural Terminology (CPT) codes), and/or an indication of whether a surgery was performed on the person. In some embodiments, determining medical condition information may comprise determining a type of injury to a person (e.g., associated with a medical injury claim) and may comprise one or more of: reviewing the injured person's medical history, accessing stored electronic data including information about the injured person's health; receiving an indication of the type of injury via a user interface (e.g., from a claim professional or other user) or input device; and/or receiving a signal including an indication of the type of injury from a client computer, server computer, and/or third-party data device.

According to some embodiments, personal information may include, without limitation, one or more of: a date of birth of a person, a gender of the person, financial information (e.g., credit score), and/or a marital status of the person. In some embodiments, employment information may include, without limitation, at least one of: a date of hire of the person, an indication of physical demand of the person's employment, an average wage, a compensation rate, an indication of whether salary is continued (e.g., while an injured worker is unable to work), and/or an employment status.

According to some embodiments, the method 600 may comprise determining an indication of a prediction that the person will develop chronic pain based on the determined information associated with the person (e.g., based on claim information, personal information, medical condition information, and/or employment information), at 606. Various ways of identifying a person (and/or determining that a person has been identified or flagged) based on information about the person and/or an associated claim are discussed in this disclosure; other ways may be apparent to those skilled in the art upon contemplation of this disclosure. In some embodiments, determining the indication may comprise determining (e.g., by a prediction model) that a patient and/or a claim should be flagged. In other embodiments, determining the indication may comprise receiving (e.g., from a prediction model) that a person or claim has been referred or accepted to a pain intervention program and/or flagged for consideration by a user for acceptance to a pain intervention program.

According to some embodiments, the method 600 may comprise receiving additional information provided by the person, at 608. According to some embodiments, additional information (i.e., information in addition to the determined claim information, medical condition information, personal information, and/or employment information) may be received from a patient by a user (e.g., via a telephone call) and/or via a patient device in accordance with a program intake procedure. In some embodiments, the additional information may be received from a user (e.g., a patient, a claim professional) via a pain intervention interface and/or may be received by a pain intervention system or user from a data storage device.

According to some embodiments, the method 600 may comprise determining at least one factor contributing to potential future chronic pain, at 610. As discussed with respect to various embodiments in this disclosure, one or more factors, contributing causes or pain drivers may be determined, for example, based on information associated with a patient, including additional information provided by a person (e.g., during a pain intervention program intake process). In some embodiments, a patient's responses to one or more program intake questions may be analyzed to identify one or more potential pain drivers that may increase the likelihood that a patient may experience chronic pain (e.g., by an acute pain condition becoming a chronic pain condition). According to some embodiments, the method 600 may comprise, based on the at least one factor, determining at least one action for preventing future chronic pain, at 612. As discussed with respect to some embodiments in this disclosure, determining at least one action for preventing future chronic pain (i.e., a preventative action) may comprise looking up (e.g., in a database) one or more resources (e.g., services of a third-party vendor) associated with a particular contributing factor.

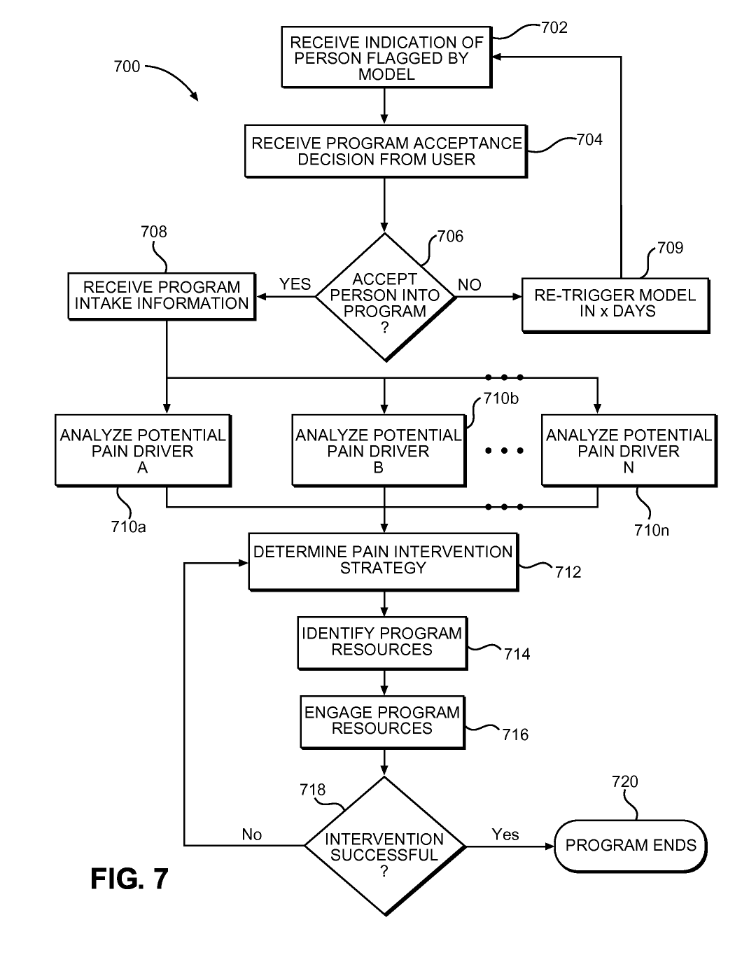

Referring now to FIG. 7, a flow diagram of a method 700 according to some embodiments is shown. The method 700 may be performed, for example, by a server computer. It should be noted that although some of the steps of method 700 may be described as being performed by a server computer (e.g., a pain management server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

According to some embodiments, the method 700 may comprise receiving an indication of a person flagged by a model (e.g., a chronic pain prediction model, a chronic pain detection model), at 702, and receiving a program acceptance decision from a user (e.g., a claim professional, a patient), at 704. In some embodiments, a person flagged by a prediction model (e.g., as indicated by an alert via a user interface) must be accepted into a pain intervention program by a user (e.g., via the user interface).

According to some embodiments, the method 700 may comprise determining whether the person is accepted into the program (e.g., based on the program acceptance decision), at 706. If not, the model may be re-triggered (e.g., for the person) in a predetermined number (x) of days (e.g., 60 days), at 709. If the person is accepted into the program (e.g., by a claim professional via a user interface), the method 700 may comprise receiving program intake information, at 708. As discussed with respect to some embodiments, a program intake process may include requesting that a person provide information related to current health, quality of life, and personal assessment of the person's pain.

According to some embodiments, the method 700 may comprise analyzing (e.g., based on information associated with the person) one or more potential pain drivers A, B, N, as represented at 710a-n. Although three example pain drivers and corresponding method steps are depicted in FIG. 7, it will be readily understood that information associated with a person may be analyzed with to respect to any number of pain drivers. In some embodiments, the method 700 may comprise determining a pain intervention strategy (e.g., including one or more recommended actions), at 712; identifying program resources (e.g., based on the pain intervention strategy), at 714; and engaging program resources (e.g., by engaging one or more service providers to provide recommended), at 716.

According to some embodiments, the method 700 may comprise determining whether a pain intervention (e.g., in accordance with a pain intervention strategy) is successful, at 718. If not, the method 700 may continue at 712 by determining a (new or modified) pain intervention strategy. If the intervention is successful (e.g., the person has not developed and/or does not appear likely to develop chronic pain), the pain intervention program ends for the person, at 720.

As described above, if a patient is not accepted into a pain intervention program, information about the patient may be analyzed by a chronic pain prediction model again (e.g., at a later time). Patient information about one or more patients may be analyzed by a model periodically (e.g., every thirty days), according to a schedule, and/or in response to a request of a user. Accordingly, a patient's information may be analyzed by a model before being accepted to a pain intervention program, after being accepted to a pain intervention program, while the patient is in a pain intervention program, and/or after the patient has completed a pain intervention program. For example, in a pain management system where every patient's data is reviewed periodically, a patient for whom a pain intervention program was successful may be analyzed by a chronic pain prediction model, and, depending on the circumstances, might be flagged by the model again.

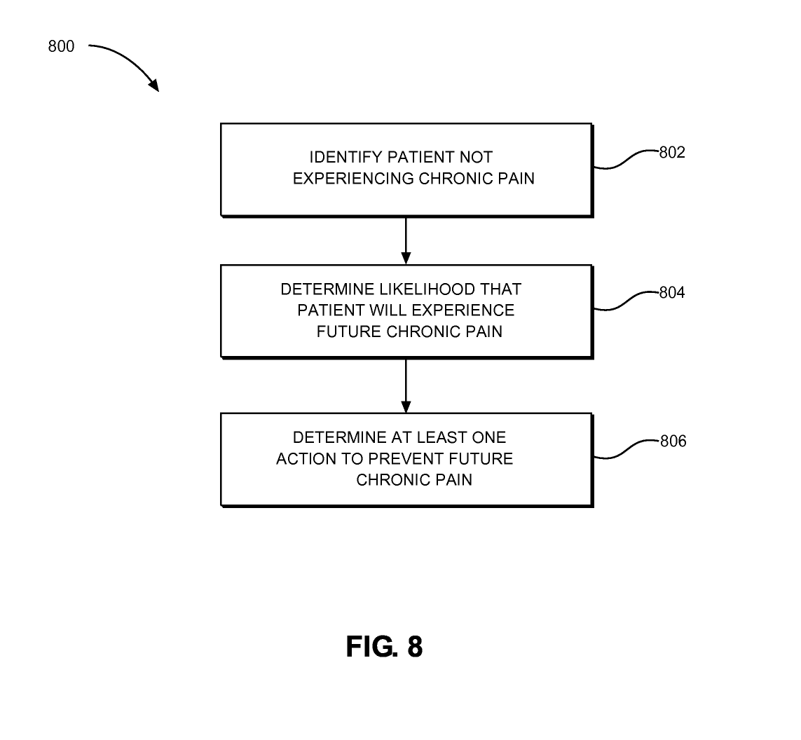

Referring now to FIG. 8, a flow diagram of a method 800 according to some embodiments is shown. The method 800 may be performed, for example, by a server computer. It should be noted that although some of the steps of method 800 may be described as being performed by a server computer (e.g., a pain management server) while other steps are described as being performed by another computing device, any and all of the steps may be performed by a single computing device which may be a mobile device, desktop computer, or another computing device. Further any steps described herein as being performed by a particular computing device may, in some embodiments, be performed by a human or another computing device as appropriate.

According to some embodiments, the method 800 may comprise identifying a patient not experiencing chronic pain (e.g., experiencing acute pain, not experiencing pain), at 802. The method 800 may further comprise determining a likelihood that the patient will experience future chronic pain, at 804, and determining at least one action to prevent future chronic pain, at 806.

According to some embodiments, a method provides for one or more of: receiving (e.g., by a specially-programmed computerized processing device), an indication that an insurance claim associated with a person is eligible for a chronic pain claim prevention program; receiving an indication that the claim is accepted into the chronic pain claim prevention program; receiving information regarding the person (e.g., one or more of information regarding an injury of the person, information regarding pain experienced by the person, and information regarding medical treatment of the injury); determining, based on the information regarding the person, a plurality of claim scores, each claim score being associated with a respective preventative action category; based on the plurality of claim scores, determining at least one preventative action for preventing the claim from becoming a chronic pain claim; and storing an indication of the at least one preventative action in association with the claim.

Any or all the methods described in this disclosure may involve one or more interface(s). One or more of such methods may include, in some embodiments, providing an interface by and/or through which a user may (i) receive and/or transmit information about a person, (ii) receive an alert that a person is flagged for possible participation in a pain intervention program, (iii) receive an indication of a prediction that a person is likely to experience future chronic pain, (iv) receive an indication of a prediction that a claim is likely to be associated with chronic pain, (v) provide a pain intervention program decision, (vi) receive an indication of at least one potential pain driver for a person, and/or (vii) receive and/or transmit an indication of at least one action and/or pain intervention strategy for preventing and/or reducing the likelihood of chronic pain for a person. Those skilled in the art will understand that interfaces may be modified in order to provide for additional types of information and/or to remove some of types of information, as deemed desirable for a particular implementation.

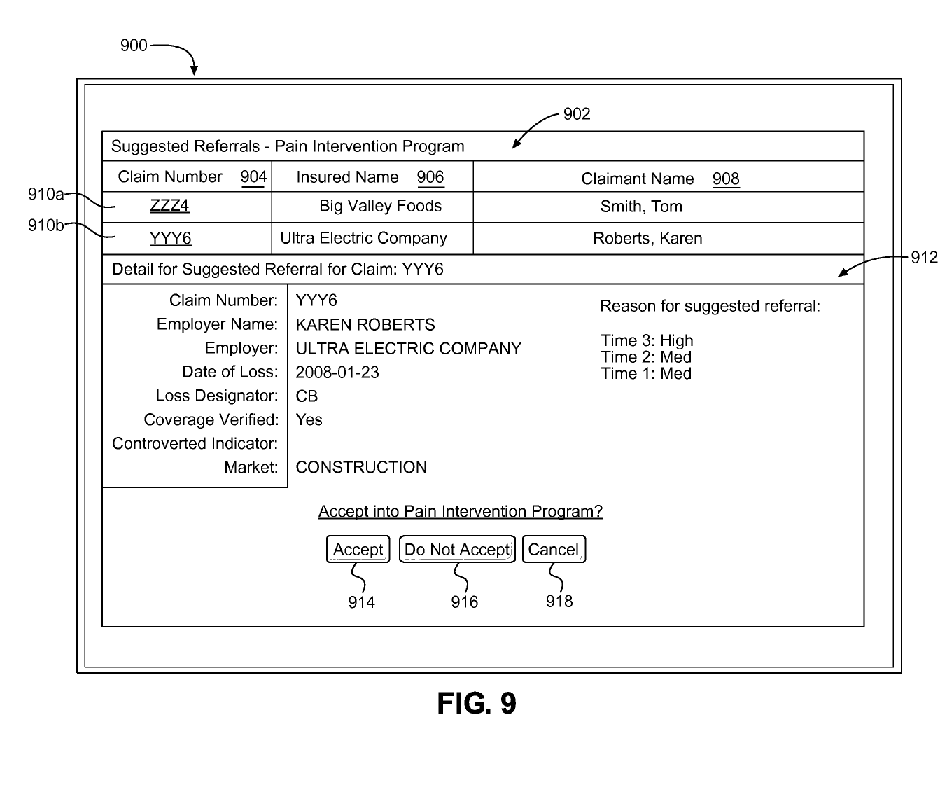

FIG. 9 illustrates an example interface 900 through which a user (e.g., claim professional) may receive an indication (e.g., an alert) that one or more claims and/or patients, injured workers, claimants, and/or other types of persons has been referred to and/or should be considered for acceptance into a pain intervention program. In particular, the example interface 900 may provide alert information portion 902 including claim number 904, insured name 906, and/or claimant name 908. As depicted in example interface 900, one or more claim identifiers a-b may include a link (e.g., a hyperlink) for accessing additional information about a claim and/or person. In one embodiment, alert information portion 902 may include an indication of a prediction with respect to the likelihood that a patient will develop chronic pain, expressed, for example, as a numeric value (e.g., percentage, ratio) and/or a description of the likelihood (e.g., high, medium, low).

As depicted in example interface 900, claim detail information portion 912 includes additional information about an example claim identified by claim number “YYY6”, including a date of loss, loss designator, indication of whether coverage is verified, an indication of market or industry, and one or more reasons why the claim and/or patient was identified (e.g., by a chronic pain prediction model). In one embodiment, one or more of alert information portion 902 and/or claim detail information portion 912 may include an indication of a prediction with respect to the likelihood that a patient will develop chronic pain, expressed, for example, as a numeric value (e.g., percentage, ratio) and/or a description of the likelihood (e.g., high, medium, low). In some embodiments, respective indications of two or more predictions may be represented, for example, with respect to predictions made at different times. The example information provided in example interface 900 includes a representation of the predictions made at Time 1 (medium (“Med”)), Time 2 (“Med”), and Time 3 (“High”), where Time 1, Time 2, and Time 3 comprise a predetermined period and/or schedule, as discussed above. According to the example, the patient's likelihood of developing chronic pain has increased since the first two times a chronic prediction model was run for the patient. Accordingly, some embodiments may provide for trend information (e.g., a table or list of values, a graph) representing the determined likelihood, as determined at different times, that a patient may develop chronic pain. In one embodiment, the trend information may indicate whether the likelihood has increased, decreased, or stayed the same over some period of time (e.g., over the last 180 days) and/or over a selected set of past predictions (e.g., the last three predictions). For example, an up arrow may represent an increase in the likelihood of chronic pain since one or more previous predictions were made.

The example interface 900 further includes interface buttons 914, 916, and 918 for accepting the claim and patient into a pain intervention program, not accepting the patient into the program, or cancelling without accepting or not accepting, respectively. In one embodiment, a claim professional may review the indicated reasons why the claim was flagged and/or other information associated with a person or claim, in order to determine whether the flagged person should be accepted into the pain intervention program, and then click on the corresponding button to provide a program acceptance decision (e.g., to a pain intervention system).

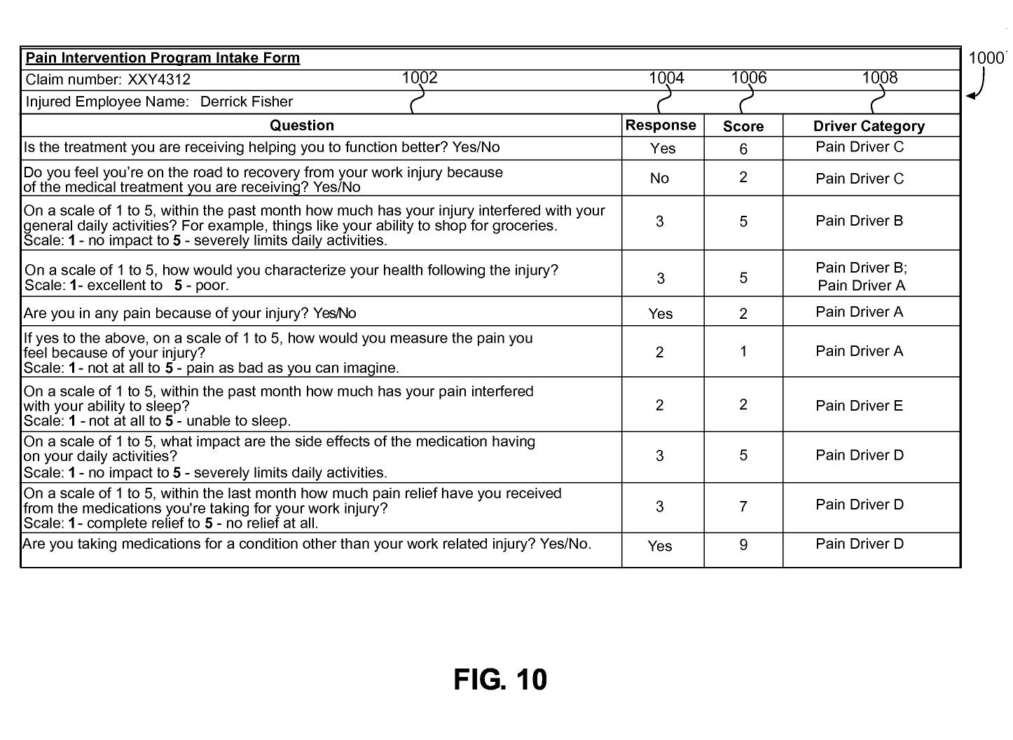

FIG. 10 illustrates an example interface 1000 through which a user (e.g., claim professional, patient) may enter information with respect to a patient. In some embodiments the information may comprise the additional information described with respect to method 600 and/or the program intake information described with respect to method 700. The example interface 1000 includes a claim information portion describing a claim number and an injured employee associated with a claim. The example interface 1000 further includes a question portion including a set of questions 1002. For each question, the example interface includes a respective response 1004 to the question, provided by the patient. In one embodiment, a user may enter the response to the question via the interface (e.g., by selecting an option from a drop-down menu).

Score 1006 includes a respective score or other metric for each question (e.g., based on the corresponding response). In some embodiments, each potential response may be mapped to a particular score and/or a score may be determined otherwise based on one or more equations, formulas, and/or rules (e.g., stored in a pain intervention program database). For example, if the potential responses to a question must be selected from a scale of 1 to 5, the corresponding score may be equal to the selected number and/or a formula or weighted mapping may be applied to the selected number to derive a score for the question (e.g., an answer of 1 or 2 is mapped to a score of 1; 3 is mapped to a score of 5; 4 is mapped to a score of 9; 5 is mapped to a score of 10). In another example, answers of “Yes”, “No”, “Sometimes”, and the like, may be mapped to respective scores and represented in score 1006 (e.g., “Yes” corresponds to a score of 6). Different mappings may be implemented for different questions (e.g., a response of “2” for one question may result in a different score than the same response given for a different question). Although some examples of responses and systems and/or formulas for determining corresponding scores may be described in this disclosure, it will readily understood that such examples are not intended to be limiting, and that other systems for scoring and/or mapping responses to scores may be utilized as deemed desirable for a particular implementation.

In some embodiments, as discussed in this disclosure, identifying one or more pain drivers that may contribute to the likelihood that a patient may experience chronic pain may comprise determining a score, based on information associated with a patient, for a particular pain driver. Example interface 1000 comprises a respective driver category 1008 that includes a description of one or more example pain drivers associated with a particular question and its score. Example pain drivers may include, for example, Effectiveness of Current Treatment, Comorbidity, Functional Ability, Age, Pain Intensity, Psychiatric Issues, and/or Substance Abuse/Addiction. In one example, determining whether a pain driver (e.g., “Pain Driver C”) is a potential pain driver for a patient may comprise summing all of the scores for the questions associated with that pain driver. For instance, based on the responses to the example questions in the example interface 1000 that are associated with the “Pain Driver C” pain driver, that pain driver may be associated with a total score of: 6+2=8. As discussed in this disclosure, if a score for a particular pain driver exceeds a predetermined threshold score, that pain driver may be selected (e.g., by a processing device in accordance with a pain driver analysis module) as a pain driver for the particular patient.

In accordance with one or more embodiments, it may be desirable not to include an indication of the question scores and/or of the corresponding pain driver categories via a user interface (e.g., when generated for display to a patient and/or to a third party). In some embodiments, one or more fields may be included in the example interface 1000 for including comments and/or other types of notes (e.g., describing a patient's explanation of and/or additional detailed information regarding one or more responses).

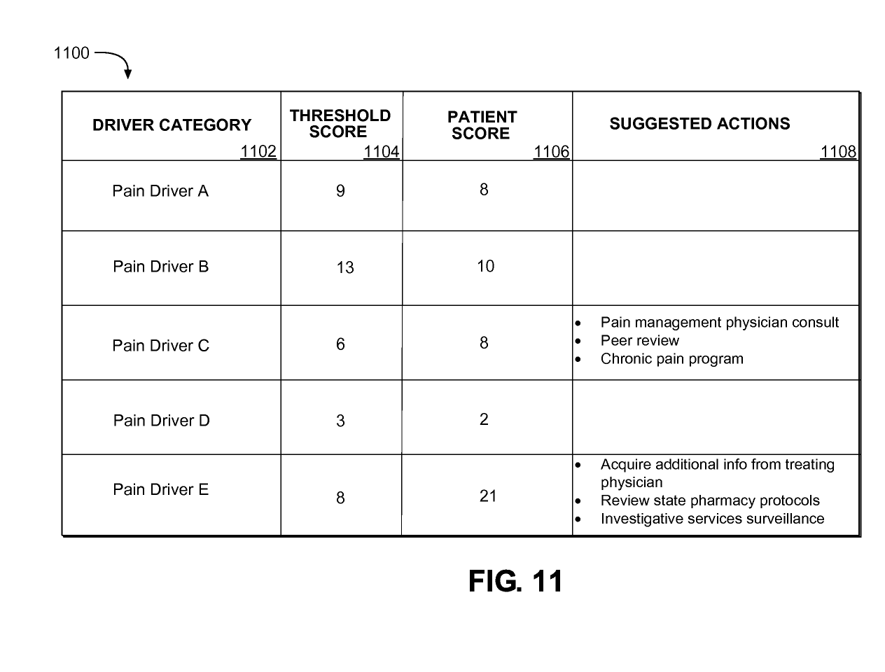

FIG. 11 illustrates an example interface 1100 for presenting to a user (e.g., claim professional, medical professional) an indication of one or more driver categories 1102 for indicating a potential pain driver. The example interface 1100 further comprises, for each driver category 1102, a respective threshold score 1104, patient score 1106, and/or suggested actions 1108. As described in this disclosure, determining one or more pain drivers and/or determining one or more suggested actions may comprise scoring or otherwise analyzing information regarding a patient (e.g., information provided by a patient accepted into a pain intervention program). Patient score 1106, for example, may include an indication of a patient's total score for a given driver category based on a sum of the respective question scores for questions associated with that driver category. A patient score for a pain driver may then be compared (e.g., in accordance with instructions of a pain driver analysis module) to the corresponding threshold score 1104 to determine if that pain driver is likely to contribute to chronic pain and/or to determine whether one or more actions associated with the pain driver should be suggested (e.g., to a user). Suggested actions 1108 includes examples of one or more actions, resources, and/or tools associated with a particular driver category. In some embodiments, if a patient score exceeds the corresponding threshold score, then suggested actions for the corresponding pain driver may be displayed to the user via a user interface. For example, suggested actions 1108 in the example interface 1100 are represented only for those driver categories whose threshold scores were exceeded by the corresponding patient scores. Alternatively, or in addition, potential actions to take may be displayed to the user regardless of the patient's score, and any patient score exceeding the threshold score may be highlighted or otherwise displayed to indicate to a user that the user should could consider the suggested actions for that pain driver. In some embodiments, all of the suggested actions associated with a pain driver (e.g., as stored in a database of resources) may be displayed to a user; in other embodiments, a subset of one or more actions may be selected from a set of suggested actions for the driver category.

According to one example implementation of a chronic pain prediction model and/or pain intervention system, in accordance with one or more embodiments, after a chronic pain prediction model runs, if a claim is flagged as a possible future chronic pain claim, a claim professional (e.g., an employee of an insurance company) is notified by an alert or other indication via a claim handling interface, suggesting referral of the patient to a pain intervention program. When the claim professional, for example, clicks on a link for a referred claim, the user is presented with additional information for the flagged claim, including one or more reasons that caused the claim to be flagged. If the claim professional must make a decision about acceptance of the patient into a chronic pain intervention program, the claim professional can make an informed decision based on the detailed information. If the claim professional accepts the claim into the program, the user can complete an associated pain intervention intake form by posing questions to the injured person (e.g., an injured employee) in order to collect information useful in determining the contributing cause(s) of future chronic pain.

### INTERPRETATION

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

Neither the Title (set forth at the beginning of the first page of this disclosure) nor the Abstract (set forth at the end of this disclosure) is to be taken as limiting in any way as the scope of the disclosed invention(s).

The phrase “based on” does not mean “based only on”, unless expressly specified otherwise. In other words, the phrase “based on” describes both “based only on” and “based at least on”.

When a single device or article is described herein, more than one device or article (whether or not they cooperate) may alternatively be used in place of the single device or article that is described. Accordingly, the functionality that is described as being possessed by a device may alternatively be possessed by more than one device or article (whether or not they cooperate).

Similarly, where more than one device or article is described herein (whether or not they cooperate), a single device or article may alternatively be used in place of the more than one device or article that is described. For example, a plurality of computer-based devices may be substituted with a single computer-based device. Accordingly, the various functionality that is described as being possessed by more than one device or article may alternatively be possessed by a single device or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format, such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “computer-readable memory device”, and/or “tangible media” specifically exclude signals, waves, and wave forms or other intangible or transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used in this disclosure, the terms “information” and “data” may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

In addition, some embodiments described herein are associated with an “indication”. As used in this disclosure, the term “indication” may be used to refer to any indicia and/or other information indicative of or associated with a subject, item, entity, and/or other object and/or idea. As used in this disclosure, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

As used in this disclosure, the term “network component” may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used in this disclosure, the terms “network” and “communication network” may be used interchangeably and may refer to an environment wherein one or more computing devices may communicate with one another, and/or to any object, entity, component, device, and/or any combination thereof that permits, facilitates, and/or otherwise contributes to or is associated with the transmission of messages, packets, signals, and/or other forms of information between and/or within one or more network devices. Such devices may communicate directly or indirectly, via a wired or wireless medium, such as the Internet, LAN, WAN or Ethernet (or IEEE 802.3), Token Ring, or via any appropriate communications means or combination of communications means. In some embodiments, a network may include one or more wired and/or wireless networks operated in accordance with any communication standard or protocol that is or becomes known or practicable. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), the Fast Ethernet LAN transmission standard 802.3-2002® published by the Institute of Electrical and Electronics Engineers (IEEE), or the like. Networks may be or include a plurality of interconnected network devices. In some embodiments, networks may be hard-wired, wireless, virtual, neural, and/or any other configuration of type that is or becomes known. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures, such as logins and passwords may be provided to protect proprietary or confidential information.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer-readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

What is claimed is:

1. An apparatus comprising:
a processor; and
a computer-readable memory in communication with the processor, the computer-readable memory storing instructions that when executed by the processor direct the processor to:
determine information about a claim associated with a person;
determine at least one of: information about a medical condition associated with the person, personal information associated with the person, and employment information associated with the person;
determine an indication of a prediction that the patient will develop chronic pain, based on at least one of: the information about the medical condition, the personal information, the claim information, and the employment information;
after determining the indication of the prediction, receive information provided by the person;
determine, based on the information provided by the person, at least one pain driver;
based on the at least one pain driver, determine at least one preventative action for preventing the patient from developing chronic pain; and
store an indication of the at least one preventative action in association with the claim.

2. The apparatus of claim 1, wherein the information about the medical condition comprises at least one of:
an injury type,
an indication of a diagnosis code,
an indication of whether a surgery was performed on the person,
an indication of a number of procedures performed on the person,
an indication of one or more procedures performed on the person,
an indication of an initial treatment of the person, and
an indication of an injured body part.

3. The apparatus of claim 1, wherein the employment information comprises at least one of:
an industry type,
a compensation rate,
an employment status, and
a wage of the person.

4. The apparatus of claim 1, wherein the personal information comprises at least one of:
a gender of the person, and
an age of the person.

5. The apparatus of claim 1, wherein the information about the claim comprises at least one of:
a geographical jurisdiction associated with the claim, and
an industry code.

6. The apparatus of claim 1, wherein determining the indication of the prediction comprises:
generating the prediction using a chronic pain prediction model.

7. The apparatus of claim 1, wherein the instructions further direct the processor to:
present, via a user interface, the indication of the prediction.

8. The apparatus of claim 1, wherein the indication of the prediction comprises a recommendation that the claim be referred to a chronic pain prevention program.

9. The apparatus of claim 1, wherein the instructions further direct the processor to:
receive an indication that the person is accepted into a chronic pain prevention program.

10. The apparatus of claim 1, wherein receiving the information provided by the person comprises:
receiving responses of the person to a questionnaire associated with a chronic pain prevention program.

11. The apparatus of claim 1, wherein receiving the information provided by the person comprises:
receiving the information via a user interface.

12. The apparatus of claim 1, wherein each at least one pain driver corresponds to a respective contributing cause of chronic pain for the person.

13. The apparatus of claim 1, wherein determining the at least one pain driver based on the information provided by the person comprises:
determining a first score for a first pain driver based on the information provided by the person; and
determining a second score for a second pain driver based on the information provided by the person.

14. The apparatus of claim 1, wherein determining the at least one pain driver based on the information provided by the person comprises:
determining a first score for a first pain driver based on a first answer to a first question of a chronic pain prevention program questionnaire;
determining a second score for the first pain driver based on a second answer to a second question of the chronic pain prevention program questionnaire;
summing the first score and the second score to generate a total claim score for the first pain driver; and
determining that the claim score for the first pain driver is greater than a predetermined threshold value for the first pain driver.

15. The apparatus of claim 1, wherein the instructions further direct the processor to:
present an indication of the at least one pain driver via a user interface.

16. The apparatus of claim 1, wherein determining the at least one preventative action for preventing the patient from developing chronic pain, based on the at least one pain driver, comprises:
accessing at least one first preventative action associated with a first pain driver in a database.

17. The apparatus of claim 1, wherein the at least one preventative action comprises at least one of:
a consultation by an insurance professional with a medical professional,
conducting a treatment effectiveness review,
a consultation between two medical professionals,
a peer review of a physician,
a review of medical records,
replacement of a first treating physician with a second treating physician,
a diagnostics assessment,
a nerve conduction quality assessment,
a radiological quality assessment,
a medical fraud review, and
a pain management consultation.

18. The apparatus of claim 1, wherein the at least one preventative action comprises at least one of:
identifying available light duty jobs,
ergonomic review,
surveillance of the person, and
vocational rehabilitation for the person.

19. The apparatus of claim 1, wherein the at least one preventative action comprises at least one of:
review of pharmacy guidelines, and
consultation with a pharmacist.

20. The apparatus of claim 1, wherein the at least one pain driver comprises one or more of:
effectiveness of current treatment,
functional ability of the person,
pain intensity experienced by the person,
psychiatric issues,
substance abuse, and
substance addiction.

21. The apparatus of claim 1, wherein the instructions further direct the processor to:
present an indication of the at least one preventative action via a user interface.

22. A method comprising:
determining, by a computerized processing device, information about a claim associated with a person;
determining, by the computerized processing device, at least one of: information about a medical condition associated with the person, personal information associated with the person, and employment information associated with the person;
determining, by the computerized processing device, an indication of a prediction that the patient will develop chronic pain, based on at least one of: the information about the medical condition, the personal information, the claim information, and the employment information;
after determining the indication of the prediction, receiving information provided by the person;
determining, by the computerized processing device and based on the information provided by the person, at least one pain driver;
based on the at least one pain driver, determining at least one preventative action for preventing the patient from developing chronic pain; and
storing an indication of the at least one preventative action in association with the claim.
